(19) United States
(12) Patent Application Publication
(10) Pub. No.: US 2009/0121670 A1
(43) Pub. Date: May 14, 2009

(54) CONSTRUCTIVE ARRANGEMENT IN A SOFT-STARTER

(76) Inventor: Martin Brand, Pomerode (BR)

Correspondence Address: HUGHES HUBBARD & REED LLP, ONE BATTERY PARK PLAZA, NEW YORK, NY, 10004, US

(21) Appl. No.: 12/202,470

(22) Filed: Sep. 2, 2008

(30) Foreign Application Priority Data
Nov. 11, 2007 (BR) MU8701723-7

(51) Int. Cl. H02P 1/00; H01H 50/00

(52) U.S. Cl. 318/778; 335/131

(57) ABSTRACT

The present invention refers to a soft-starter having a new constructive arrangement comprising SCRs and a by-pass contactor connected through busbars that also provide an external connection to the soft-starter. The SCRs (10) and the contacts (30, 31) of the by-pass contactor are positioned next to the heatsinks (201, 202, 203), which by their turn are interconnected to each other by a busbar (41) and connected to the supply network by a busbar (401) and to the motor by a busbar (402), the contacts (30, 31) of the by-pass contactor being set in motion by a coil (35) activated by an electrical current.

### FIELD OF THE INVENTION

The present invention refers to a soft-starter having a new constructive arrangement wherein the soft-starter is assembled with silicon controlled rectifier (SCR) stacks and by-pass contactors incorporated thereto.

### BACKGROUND OF THE INVENTION

As it is known by those skilled in the art, a number of soft-starters having a by-pass contactor incorporated thereto are currently available in the market. These soft-starters are provided with SCRs that control the voltage applied to the induction motor during the start up or ramp down of the motor. Generally speaking, the SCRs are connected in an anti-parallel fashion (also known as a W1C connection) and the soft-starters may control one, two or three phases.

One such type of soft-starter having a by-pass contactor incorporated thereto is shown in U.S. Pat. No. 6,531,940 B1, that discloses a soft-starter and contactors defined as two separate parts that can be assembled together. However, in addition to not being compact this constructive arrangement is far more complex and therefore has a higher manufacturing cost.

Other types of soft-starters assemblies are shown and discussed in U.S. Pat. No. 6,351,113 and U.S. Pat. No. 6,087,800, that disclose a soft-starter having a by-pass contactor incorporated thereto with a compact constructive arrangement. However, the contactor and the SCRs/heatsink assembly are serially mounted in such a manner as to form two groups. The problem with this constructive arrangement is that it causes an increased thermal resistance between the by-pass contactor and the heatsink.

Another type of soft-starter having a dedicated by-pass contactor incorporated thereto is available from Siemens® (3RW40/3RW44). However, this constructive arrangement does not suitably profit from the advantageous low thermal resistance between the contactor and the heatsinks.

The SCRs and the by-pass contactor are the main power elements of a soft-starter. Busbars are used to electrically connect these elements and to provide external connections to the soft-starter. As such, the SCRs are mounted between the heatsinks while the ordinary contactors can be mounted on top of or in line with the heatsinks.

While this type of soft-starter has an acceptable constructive arrangement, it increases not only the dimensions of the final product but also the thermal resistance between the contactor and the heatsink.

This is due to the fact that during the start of the motor the level of current in the SCRs is increased and the losses produce an increase in the temperature of the soft-starter. In general, heatsinks are mounted near the SCRs in order to maintain the junction temperature of the SCRs within acceptable limits. The heatsinks can be used with natural or forced ventilation, which also interferes in the dimension of the soft-starter.

In addition to the above, when the motor is running at full voltage, the by-pass contactor is closed and no current or voltage is applied to the SCRs, consequently, they are not submitted to losses. However, the contacts of the by-pass cause an increase in temperature while conducting the motor current, which is an additional drawback that has to be taken into consideration in-this constructive arrangement.

### SUMMARY OF THE INVENTION

Therefore, an objective of the present invention is to provide a soft-starter having a new constructive arrangement which topology provides a substantial reduction of the dimensions of the soft-starter.

Another objective of the present invention is to provide a soft-starter having a new constructive arrangement that causes a low thermal resistance between the by-pass contacts and the heatsinks.

A further objective of the present invention is to provide a soft-starter having a new constructive arrangement that allows the contacts of the by-pass to operate in over-current condition without causing any damages to its construction.

Yet another objective of the present invention is to provide a soft-starter having a new constructive arrangement that provides a more robust configuration to the soft-starter, albeit its compact structure, that may support instantaneous overloads of the motor.

These and other objectives and advantages of the present invention are accomplished by a soft-starter having a new constructive arrangement wherein the SCRs and the contacts of the by-pass are positioned next to the heatsinks, which by their turn are interconnected to each other by busbars, the by-pass contacts being set in motion by a coil activated by an electrical current.

### BRIEF DESCRIPTION OF THE DRAWINGS

Further features and other objects and advantages of the present invention will become apparent from the following detailed description of a presently preferred embodiment of the soft-starter shown in the attached drawings, wherein:

FIG. 1a illustrates an electrical diagram wherein a soft-starter determines one controlled phase;

FIG. 1b illustrates an electrical diagram wherein a soft-starter determines two controlled phases;

FIG. 1c illustrates an electrical diagram wherein a soft-starter determines three controlled phases;

FIG. 2a is a schematic view of the controlled phase assembly of a soft-starter according to the present innovation;

FIG. 2b is a schematic view of another controlled phase assembly of a soft-starter also according to the present innovation;

FIG. 3 shows the assembly of the soft-starter according to FIG. 2a showing the contacts in a closed position; and

FIG. 4 is a perspective view showing the controlled phase of a soft-starter according to the new constructive arrangement objective of the present innovation.

### DESCRIPTION OF THE PREFERRED EMBODIMENTS

As it can be seen from the drawings, a soft-starter having a constructive arrangement according to the present invention comprises mounting the SCRs 10 and the contacts 30, 31 of the by-pass next to the heatsinks 201, 202, 203. By their turn, the heatsinks are interconnected to each other through a busbar 41, and are connected to the supply network through a busbar 401 and to the motor (not shown) through a busbar 402. The contacts 30, 31 of the by-pass are activated by a coil 35.

A magnetic field is formed when electric current passes through coil 35, which magnetic field pulls the plunger 33 of the coil against its fixed core 32. Therefore the contact carrier 34 of coil 35, which is attached at one of its ends to the plunger 33 and at its other end to the moveable contacts 31, is displaced together with the plunger 33 towards the fixed core 32 and simultaneously pushes the moveable contacts 31 in the direction of the fixed contacts 30, which are connected to the busbars 401, 402, therefore closing the contacts of the by-pass as shown in FIG. 3.

The simultaneous relative displacement of the cores 32, 33 of the coil 35 and of the contacts 30, 31 of the by-pass contactor is only possible because the contact carrier 34 is positioned orthogonally to the busbars 401, 402, which have a trespassing window 36 aligned with the opening of the heatsinks 201, 202 in the point where they intersect with the contact carrier 34, through which window the end of the contact carrier 34 passes between the busbars 401, 402 and the heatsinks 201, 202 until the contacts 30, 31 are in a closed position. The opening between the heatsinks 201, 202 is defined by the height of the SCRs 10.

This constructive arrangement assures a low thermal resistance between the by-pass contactor and the heatsinks due to the fact the contacts 30 are welded onto the copper busbars 401, 402, which are directly mounted to the heatsinks 201, 202. In this manner the contacts 30, 31 of the by-pass can be optimized in size. This, together with the fact that the by-pass contactor is mounted next to the heatsinks 201, 202 allow for larger over-currents to be supported by said contacts 30, 31. This increases the robustness of the final product against instantaneous overloads of the motor.

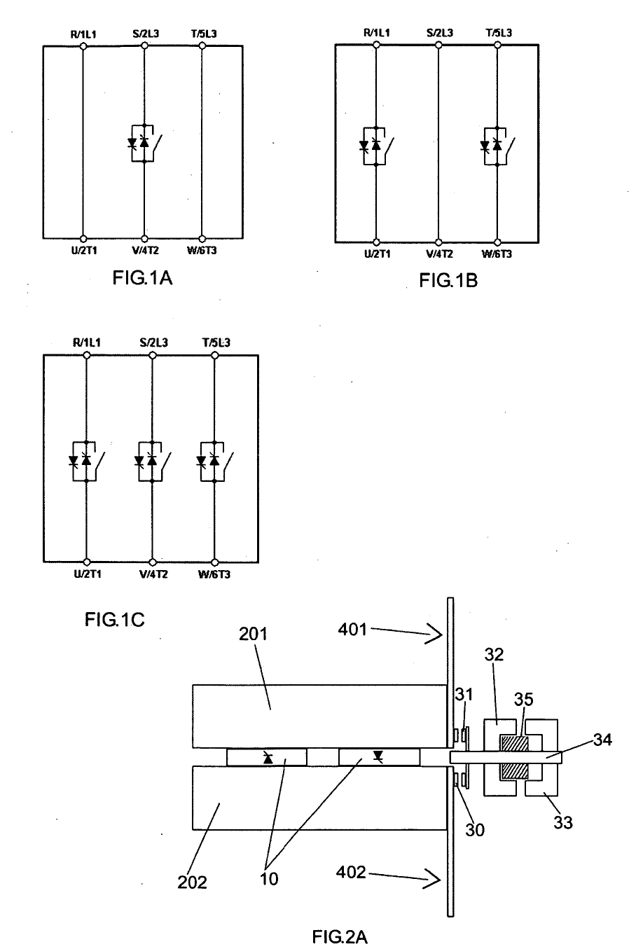

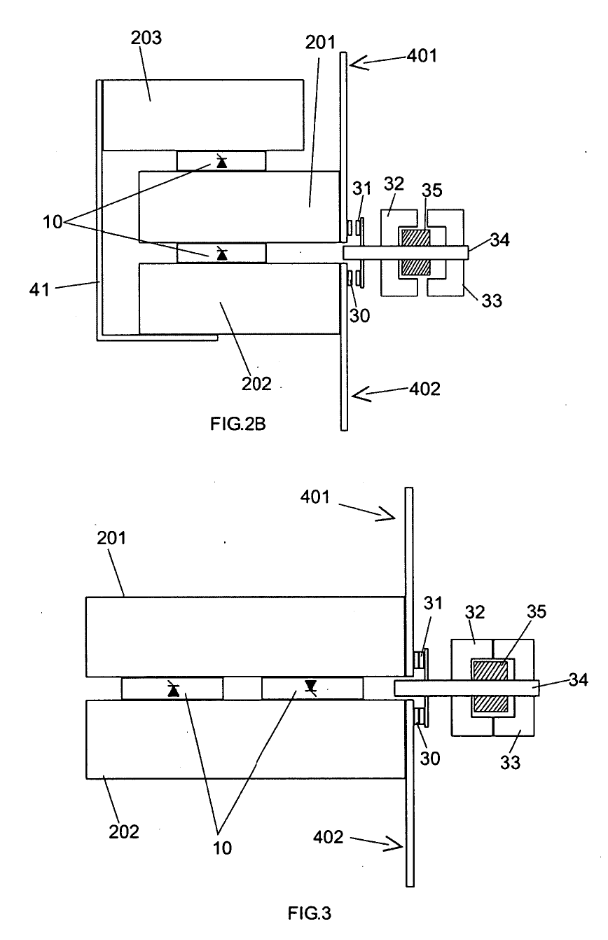

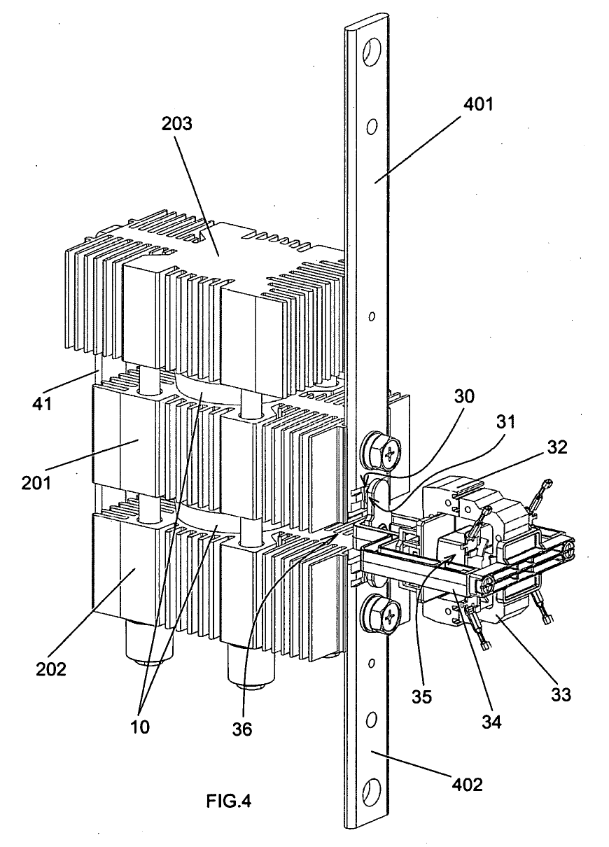

As it can be seen from FIG. 2b, the soft-starter has a W1C connection where the SCRs 10 are assembled between three heatsinks 201, 202, 203, two of which are connected to the busbars 401, 402 thus making the electrical connections, and functioning as terminals of the soft-starter. One busbar 41 makes the W1C connection interconnecting a third heatsink 203 to the heatsink 202.

While preferred constructive arrangements of the soft-starter according to the present invention have been described and illustrated, it shall be noted that other compact constructive arrangements can be accomplished without departing from the scope of the present innovation.

What is claimed is:

1. A soft-starter having a new constructive arrangement comprising SCRs and a by-pass contactor connected through busbars that also provide an external connection to the soft-starter, wherein the SCRs and contacts of the by-pass contactor are positioned next to one or more heatsinks, which by their turn are interconnected to each other by a first busbar and connected to the supply network by said first busbar and to the motor by a second busbar, the contacts of the by-pass contactor being set in motion by a coil activated by an electrical current.

2. A soft-starter having a new constructive arrangement as claimed in claim 1, wherein a contact carrier of the coil is attached at one of its ends to a plunger and at its other end to the moveable contacts of the by-pass contactor, said contact carrier being orthogonally mounted relative to said busbars which have a trespassing window formed therebetween to allow passage to the opening of the heatsinks, through which the end of the contact carrier advances between said busbars and the heatsinks until the contacts of the by-pass contactor are in the closed position.

3. A soft-starter having a new constructive arrangement as claimed in claim 1 or 2, wherein the opening between the heatsinks is defined by the height of the SCRs and the shape of the heatsinks.

4. A soft-starter having a new constructive arrangement as claimed in claim 1, wherein the SCRs are assembled between the heatsinks, two of which are connected to the busbars thus making the electrical connections and functioning as terminals for the soft-starter, while a third busbar forms a W1C connection, interlinking a third heatsink to the one of the first two heatsinks.

5. A soft-starter having a new constructive arrangement as claimed in claim 1, wherein the soft-starter has one, two or three controlled phases.
